(19) United States
(12) Patent Application Publication
(10) Pub. No.: US 2026/0135124 A1
(43) Pub. Date: May 14, 2026

(54) SEPARATOR FOR FUEL CELL

(71) Applicant: TOYOTA JIDOSHA KABUSHIKI KAISHA, Toyota-shi (JP)

(72) Inventors: Kyosuke HAYASHI, Toyota-shi (JP); Tohru ODA, Toyota-shi (JP); Takami UMEDA, Miyoshi-shi (JP)

(73) Assignee: TOYOTA JIDOSHA KABUSHIKI KAISHA, Toyota-shi (JP)

(21) Appl. No.: 19/279,346

(22) Filed: Jul. 24, 2025

(30) Foreign Application Priority Data
Nov. 13, 2024 (JP) 2024-197869

(51) Int. Cl. H01M 8/0247; H01M 8/026; H01M 8/0263; H01M 8/1004

(52) U.S. Cl. CPC H01M 8/0247; H01M 8/026; H01M 8/0263; H01M 8/1004

(57) ABSTRACT

A separator disclosed in the present specification includes a flat plate substrate of a rectangle, a gas flow channel groove provided in the substrate, a first protrusion provided at at least one of four corners of the substrate, and a plurality of second protrusions provided in the substrate so as to surround the first protrusion. The first protrusion and the second protrusion have a hollow inside. The first protrusion and the second protrusion have different heights. A distance between the first protrusion and each of the second protrusions is smaller than a manufacturing tolerance of the width of the gas flow channel groove.

### CROSS-REFERENCE TO RELATED APPLICATION

This application claims priority to Japanese Patent Application No. 2024-197869 filed on Nov. 13, 2024. The disclosure of the above-identified application, including the specification, drawings, and claims, is incorporated by reference herein in its entirety.

### BACKGROUND

### 1. Technical Field

The technique disclosed in the present specification relates to a separator for a fuel cell.

### 2. Description of Related Art

In a fuel cell, a separator is disposed between two adjacent membrane electrode assemblies (MEAs). The separator for a fuel cell is often made of a metal plate having a thickness of 1.0 mm or less. The separator is provided with a gas flow channel groove through which oxygen (air) or hydrogen flows. In a manufacturing process of the fuel cell, a plurality of separators is stacked and prepared. The gas flow channel groove is made by performing press processing on a thin flat plate substrate. The gas flow channel groove has a recessed shape when viewed from one surface of the substrate and has a protruding shape when viewed from an opposite surface thereof. That is, a protruding (recessed) shape having the same size as a recessed (protruding) shape of one surface of the substrate is provided on a back side of the recessed (protruding) shape of the one surface of the substrate. Therefore, in a case where the separators are stacked, the gas flow channel grooves of the upper and lower separators are stuck together, and it is difficult to pick up the separators one by one.

Japanese Unexamined Patent Application Publication No. 2007-115600 (JP 2007-115600 A) discloses a technique of sending air into a space between the second separator from the top and the top separator when the top separator is picked up, and making it easier to remove the top separator.

### SUMMARY

The present specification provides a technique of making it easier to separate a lower separator when the top separator is picked up from a plurality of stacked separators by devising a shape of the separator.

A separator disclosed in the present specification includes:
a substrate that is a rectangular flat plate;
a gas flow channel groove provided in the substrate;
a first protrusion provided at at least one of four corners of the substrate; and
a plurality of second protrusions provided in the substrate to surround the first protrusion.
The first protrusion and the second protrusion are hollow.
The heights of the first protrusion and the second protrusion are different. The distance between the first protrusion and the second protrusion is smaller than a manufacturing tolerance of the width of the gas flow channel groove.

In the separator disclosed in the present specification, when the separators are stacked, the gas flow channel groove of the upper separator and the gas flow channel groove of the lower separator may overlap, but the first protrusion and the second protrusion do not necessarily overlap. The first protrusion of the lower (upper) separator is highly likely to overlap the second protrusion of the upper (lower) separator. The heights of the first protrusion and the second protrusion are different. When the protrusion of the lower separator having a large height overlaps the protrusion of the upper separator having a small height, a gap is secured between the gas flow channel grooves of the upper and lower separators. The likelihood of the lower separator remaining stacked when the upper separator is picked up is reduced.

Details of the technique and further improvements disclosed in the present specification will be described in “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view of a separator of an embodiment;

FIG. 2 is a cross-sectional view of a separator taken along a line II-II of FIG. 1;

FIG. 3 is a cross-sectional view of two overlapping separators; and

FIG. 4 is a cross-sectional view of two overlapping separators (second embodiment).

### DETAILED DESCRIPTION OF EMBODIMENTS

### First Embodiment

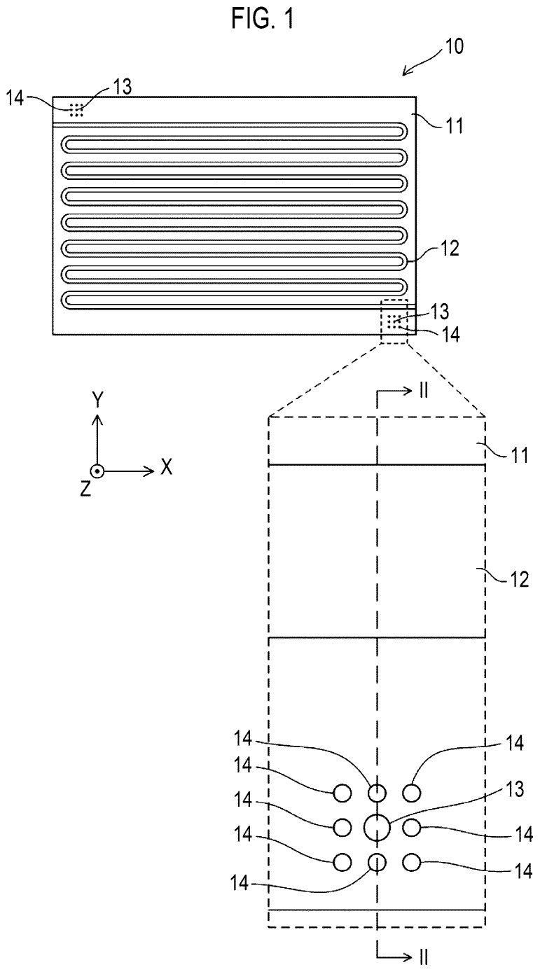

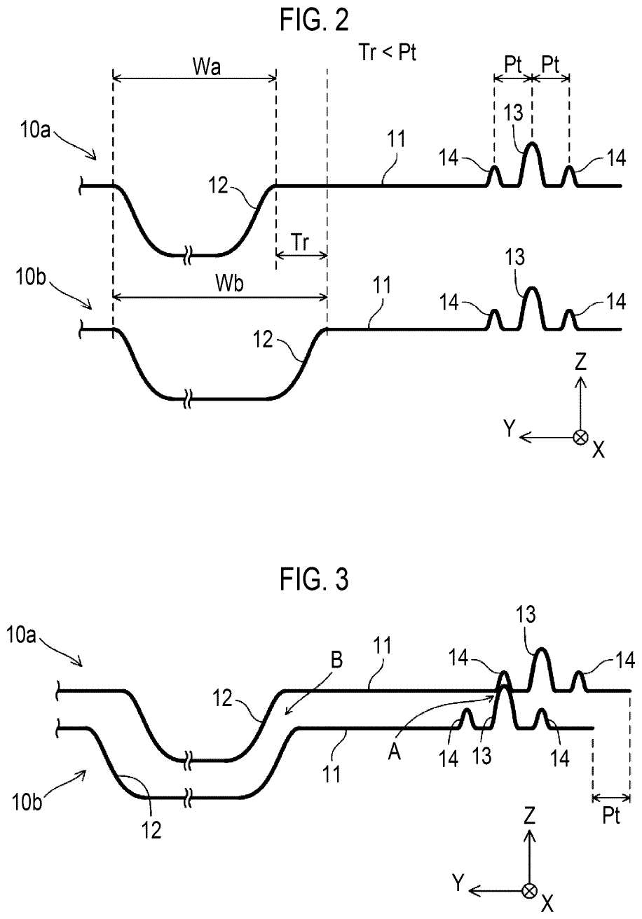

A separator 10 of a first embodiment will be described with reference to the drawings. The separator 10 is a component disposed between two adjacent membrane electrode assemblies (MEAs) in the fuel cell. FIG. 1 is a plan view of a separator 10. FIG. 1 also shows an enlarged view of the lower right corner of the separator 10. FIG. 2 is a cross-sectional view of the separator 10 cut along the line II-II of FIG. 1.

The separator 10 is a thin metal plate provided with the gas flow channel groove 12 and two kinds of protrusions (a first protrusion 13 and a second protrusion 14). In the following, the first protrusion 13 and the second protrusion may be collectively referred to as protrusions 13, 14.

A metal plate that is a base material of the separator 10 is referred to as a substrate 11 in the present specification. The gas flow channel grooves 12 and the protrusions 13, 14 are made by press processing. Therefore, the gas flow channel groove 12 has a recessed shape on one surface of the substrate 11 and has a protruding shape on the opposite surface. On the other hand, the protrusions 13, 14 have a protruding shape on one surface of the substrate 11 and have a recessed shape on the opposite surface. Therefore, the gas flow channel groove 12 is a hollow, and the protrusions 13, 14 have a hollow dome shape.

Although the gas flow channel grooves 12 are provided on each of both surfaces of the substrate 11, in the drawing, the gas flow channel grooves on the other surface are not shown. In the fuel cell stack, oxygen flows through the gas flow channel grooves on one surface of the separator 10, and hydrogen flows through the gas flow channel grooves on the other surface.

The substrate 11 is rectangular in plan view, and the protrusions 13, 14 are provided at two corners of the diagonal of the rectangular substrate 11. One first protrusion 13 and a plurality of second protrusions 14 are disposed at one corner of the substrate 11. As shown in the enlarged view of FIG. 1, the second protrusions 14 are disposed to surround the first protrusion 13. In the present embodiment, eight second protrusions are disposed so as to surround the first protrusion 13. In other words, the first protrusion 13 is disposed at the center of the distribution of the second protrusions.

FIG. 2 is a cross-sectional view of the separator 10 cut along the line II-II of FIG. 1. In other words, FIG. 2 shows a cross section of the separator cut along a line crossing the gas flow channel groove 12 and the first protrusion 13. FIG. 2 shows two separators, and in order to distinguish the separators, one separator (upper separator in FIG. 2) is referred to as a separator 10a, and the other separator (lower separator in FIG. 2) is referred to as a separator 10b.

As shown in FIG. 2, the first protrusion 13 is higher than the second protrusion 14. Further, the gas flow channel grooves 12 are disposed in each of the separators 10a, 10b, but the width Wa of the gas flow channel groove 12 of the separator 10a and the width Wb of the gas flow channel groove 12 of the separator 10b are different. The difference Tr in the widths of the two gas flow channel grooves 12 results from a manufacturing tolerance in the width of the gas flow channel groove 12. A distance Pt between the first protrusion 13 and the second protrusion 14 is smaller than a manufacturing tolerance Tr of the width of the gas flow channel groove 12.

The first protrusion 13 and the second protrusion 14 provide the following advantages. FIG. 3 shows a diagram in which the separators 10a, 10b are overlapped. There is a difference of a manufacturing tolerance Tr in the width of the gas flow channel grooves 12 of the separator 10a and the separator 10b. Therefore, even when the separators 10a, 10b are misaligned by the distance Pt in the Y direction of the coordinate system in the figure, the gas flow channel groove 12 of the separator 10a and the gas flow channel groove 12 of the separator 10b overlap each other. As shown in FIG. 3, at this time, the first protrusion 13 of the lower separator 10b overlaps the second protrusion 14 of the upper separator 10a. Since the first protrusion 13 is higher than the second protrusion 14, the first protrusion 13 and the second protrusion 14 overlap each other, and a gap is secured between the gas flow channel groove 12 of the separator 10a and the gas flow channel groove 12 of the separator 10b. An arrow A of FIG. 3 indicates a contact point between the lower first protrusion 13 and the upper second protrusion 14, and an arrow B indicates a gap between the upper and lower gas flow channel grooves 12 of the separators 10a, 10b. The gas flow channel grooves 12 of the separators 10a, 10b overlap each other when viewed from the normal direction of the substrate 11, but a gap is secured between the gas flow channel grooves 12. Due to the gap, the lower separator 10b is easily separated when the upper separator 10a is picked up.

Even when the separators 10a, 10b are misaligned by the distance Pt in the Y direction, the gas flow channel grooves 12 of the upper and lower separators 10a, 10b overlap each other. When a large number of separators 10 are stacked, a distance Pt between the separators 10 in the Y direction is varied, but the gas flow channel grooves 12 of all the separators 10 overlap each other. Therefore, stacking the separators 10 is allowable in the manufacturing process of the fuel cell.

As described above, the first protrusion 13 and the second protrusions are provided on the substrate 11, whereby the second separator 10 is easily separated when the top separator 10 is lifted from the bundle of the stacked separators 10. A plurality of second protrusions 14 are disposed to surround one first protrusion 13, and the first protrusion 13 is higher than the second protrusions. In addition, a distance Pt between the first protrusion 13 and the second protrusion 14 is smaller than a manufacturing tolerance Tr of the width of the gas flow channel groove 12. According to the relationship, when a plurality of the separators 10 are stacked, the gas flow channel grooves overlap each other, but the first protrusions do not overlap each other, and the first protrusions 13 of the upper (lower) separator 10 may overlap the second protrusions 14 of the lower (upper) separator 10. The first protrusion 13 of the upper (lower) separator 10 overlaps the second protrusion 14 of the lower (upper) separator 10, so that a gap is secured between the gas flow channel grooves of the two separators 10. Since the gap is continuous with the space around the separator 10, air enters the gap from the surroundings when the upper separator 10 is lifted. As a result, the lower separator 10 is easily separated when the upper separator 10 is lifted.

In FIG. 3, a case where two separators 10a, 10b are misaligned in the Y direction of the coordinate system in the figure is shown. The same advantages can be obtained even when the two separators 10a, 10b are misaligned in the X direction of the coordinate system in the figure. The same advantages can be obtained even when the two separators 10a, 10b are misaligned in any direction in the XY plane of the coordinate system in the figure.

### Second Embodiment

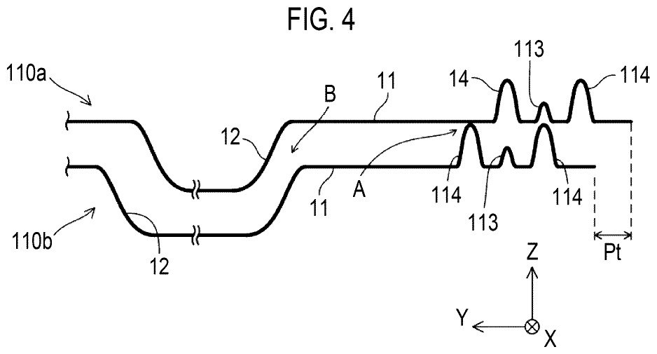

FIG. 4 is a cross-sectional view of two separators 110a, 110b of the second embodiment overlapping each other. A second protrusion 114 is disposed around the first protrusion 113. As in the case of the separator 10 of the first embodiment, the second protrusions 114 are disposed to surround the first protrusion 113 in the plane of the substrate 11.

In the separators 110a, 110b of the second embodiment, the first protrusion 113 is lower than the second protrusion 114. Even in this case, when the upper separator 110a and the lower separator 110b are overlapped to be misaligned by a distance Pt in the Y direction, the upper and lower gas flow channel grooves 12 overlap each other, and a gap is secured between the upper and lower gas flow channel grooves 12 (the portion indicated by the arrow B in FIG. 4). In this case, the one second protrusion 114 of the lower separator 110b contacts the substrate 11 of the upper separator 110a (place of arrow A in FIG. 4), and a gap is secured between the upper and lower gas flow channel grooves 12. That is, the first protrusion 13 (113) and the second protrusion 14 (114) need only have different heights.

Points to consider regarding the technique described in the embodiment will be described. In the separator 10 of the embodiment, a set of protrusions 13, 14 is provided at two diagonally opposite corners of the substrate 11. The protrusions 13, 14 need only be provided at at least one of the four corners of the substrate 11.

The disposition of the second protrusions 14, 114 is not limited to the disposition of the embodiment. The second protrusions need only be disposed to surround the first protrusion. However, it is preferable that four or more second protrusions surround the first protrusion and are disposed at equal intervals.

The width of the gas flow channel groove 12 is approximately 0.5 [mm], and the manufacturing tolerance of the width is approximately 0.05 [mm]. A distance Pt between the first protrusion 13 and the second protrusion 14 need only be substantially 0.04 [mm] or less.

Although specific examples of the aspect of the disclosure have been described above in detail, the examples are merely illustrative and are not intended to limit the scope of the claims. The technology described in the claims includes various modifications and changes of the specific examples exemplified above. The technical elements described in the present specification or the drawings exhibit technical usefulness alone or in various combinations, and are not limited to the combinations described in the claims at the time of filing. Further, the technology exemplified in the present specification or the drawings can achieve a plurality of objectives at the same time, and achieving one of the objectives has technical usefulness.

What is claimed is:

1. A separator for a fuel cell, the separator comprising:
a substrate that is a rectangular flat plate;
a gas flow channel groove provided in the substrate;
a first protrusion provided at at least one of four corners of the substrate; and
a plurality of second protrusions provided in the substrate to surround the first protrusion, wherein:
the first protrusion and the second protrusion are hollow;
heights of the first protrusion and the second protrusion are different; and
a distance between the first protrusion and the second protrusion is smaller than a manufacturing tolerance of a width of the gas flow channel groove.
